(19) United States
(12) Patent Application Publication
(10) Pub. No.: US 2008/0201515 A1
(43) Pub. Date: Aug. 21, 2008

(54) Method and Systems for Interfacing With PCI-Express in an Advanced Mezannine Card (AMC) Form Factor

(76) Inventors: Scott Birgin, Champlin, MN (US); William Chu, Elmsford, NY (US); David Lentz, Hopkins, MN (US); Viswa Sharma, San Ramon, CA (US); Chris Sonnek, Centerville, MN (US); Ming Siu Tseng, Fremont, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/034,543

(22) Filed: Feb. 20, 2008

Related U.S. Application Data
(60) Provisional application No. 60/890,779, filed on Feb. 20, 2007.

(51) Int. Cl. G06F 13/20

(52) U.S. Cl. 710/313

(57) ABSTRACT

A cage that is received with a Personal Computer (PC) enclosure in the same manner a peripheral can be received within the PC. The cage is provided with fans, circuitry, connectors and structural features to create a ATCA or MicroTCA type environment required for the operation of an AMC card. The cage features a lateral connector for connecting to the motherboard and transferring PCI-Express protocolized signals between the cage and the CPU. The cage also features means to receive and support an AMC card within the ATCA and MicroTCA environment created for it by the cage. In this configuration, the CPU can communicate with the AMC card using the PCI-Express interconnect protocol as if the AMC card is another peripheral I/O device. In this manner, an advanced form factor AMC card may be tested and used within a PC environment suitable only for conventional form factor expansion cards and peripheral I/O devices.

### FIELD OF THE INVENTION

The present invention relates generally to computer and circuit packaging and housing. More particularly, the present invention relates to bridging and converting in all aspects a PCI-SIG specified PCI-Express interface to a PICMG specified Advanced Mezzanine Card (AMC) interface, including, form factor, electrical signal, management software, thermal management in a standards based modular chassis arrangement.

### BACKGROUND

The telecom and computing industry is increasingly gravitating towards commercial off-the-shelf (COTS) technology. Proprietary hardware and software systems are no longer favored. This shift is evident in the shift towards open standards based platforms and standardized chassis solutions for next-generation telecommunication and high performance equipment, such as for example, switches, routers, telecom racks, servers and other components and systems. These open standards are in the form of specifications arrived at by industry sponsored standardization bodies.

An exemplary specification is the PCI Industrial Computer Manufacturers Group (PICMG®) family of specifications, denominated PICMG® 3.x, that cover diverse communications applications. PICMG 3.0, the base specification, that drives the Advanced Telecom Computing Architecture or AdvancedTCA™ (hereinafter “ATCA”) defines the electrical, mechanical, system management, power, fabric interface and Base interface to cover scalable, standardized platform architectures that extend COTS to a broad spectrum of products and components in the vendors' marketplace. These products include high-availability, carrier-grade telecom, storage and computing applications. ATCA compliant components and systems embody interoperable ATCA technology such as physical format, system management and software designed to deliver cost effective, reduced time-to-market, off-the-shelf solutions for suppliers and customers.

Another widely accepted specification is the PICMG® Advanced Mezzanine Card (AMC) specification. AMC modules generally comply with a “base” or “core” specification denominated as AMC.0 which defines the modules form factor, dimensions, connector mechanicals, power requirements and so forth. The base specification also requires every AMC to support a basic level of hardware management functionality such as type, thermal, availability. AMCs that conform to this base specification may use proprietary LVDS based signaling or, connectivity infrastructures that conform to one or more subsidiary specifications denominated AMC.x (for example, AMC.1 (PCI-Express), AMC.2 (Gigabit Ethernet and XAUI), AMC.3 (SAS/SATA) or AMC.4 (Serial RapidIO)) each targeted to specific applications. The base-level requirements for high-speed mezzanine cards such as those used by ATCA based carrier cards (hereinafter “carrier board) include, for example, the form factor, connector topology, thermal characteristics, power, management, clocking and base fabric as set forth in PICMG AMC.0. Advanced Mezzanine Card Short Form Specification (“AMC Specification”) Version D0.9a published Jun. 15, 2004, and Version D0.97, published Sep. 17, 2004 (“AMC Spec D0.97”) the entire contents of which are incorporated herein by reference. By definition, the Advanced Mezzanine Card is a modular add-on card (hereinafter “AMC”) that extends the functionality of an ATCA based Carrier board. The AMC base specification defines a protocol indifferent connector (“AMC Connector”) to enable electro-mechanical coupling of the AMC card to the Carrier board.

These industry standard specifications like ATCA and AMC have been so widely accepted that use of these standards has migrated to industry segments other than communications and in non-telecom products. This migration is accompanied by the realization that many non-telecom applications do not necessarily need the entire ATCA specification. Technology implementations based on the ATCA specification represent “big iron” solutions that are suited to Telco central offices with high density needs: i.e., switching systems and transmission cross connects. These chasses are too massive for remote/enterprise applications. Likewise, ATCA blades feature a form factor that makes them unsuitable for edge applications such as cellular base stations, wireline fiber pedestals, workgroup routers, modular servers, SAN storage boxes, network hubs (Wi-Fi/Wi-MAX), military, aeronautical, and medical applications. In response, the members of PICMG have recently ratified the MicroTCA specification (MicroTCA.0 R1.0, Jul. 6, 2006) (hereinafter “the MicroTCA specification”). In fact, the Micro Telecommunications Computing Architecture (MicroTCA) specification is ideally suited for AMC based applications that do not need big boxes. AMC modules may be used without modification in both the ATCA and MicroTCA specification compliant systems. The thrust of MicroTCA is the reuse of technology defined by the AMC standard. The MicroTCA system architecture allows the AMC to be plugged directly into the MicroTCA backplane via the AMC Connector. The MicroTCA system architecture makes it possible to achieve high data rates over the MicroTCA backplane using high-speed serial interconnect. Functionally specialized AMC cards may communicate with other AMC cards over the backplane interconnects via Serdes interfaces (such as GbE Serdes interfaces) implemented using, for example, bridge chips or an FPGA. In addition to the serial interface, the AMC connector also makes provision for an IPMI interface. MicroTCA supports a reduced scale, low cost, low power, reduced system footprint solution with advanced management facilities. The MicroTCA form factor targets communications equipment ranging from pole mounted devices to core routers and IP-gateways, radio base stations and switching centers. MicroTCA may be considered to be a repackaging of modular ATCA/AdvancedMC blades.

By eliminating the ATCA carrier, MicroTCA allows AdvancedMC modules to be used directly in compact, low-cost enclosures, from standalone housings to standard rack-mount systems. The MicroTCA enclosure acts as a virtual carrier (VC), emulating the ATCA carrier environment specified in AMC.0. The virtual carrier provides interconnect, power conversion, clock distribution, fabric features and system management functionality of the ATCA specification and capable of supporting a plurality of AMC cards. PICMG® ratified the PICMG MTCA.0 Specification (i.e. the MicroTCA) in July of 2006.

PICMG 3.x series specifications define standards for different kinds of protocols. For example, the PICMG® 3.4 Specification defines the PCI-Express signals to be used by a motherboard that is connected with PICMG 3.0 backplane. PCI and PCI-Express protocols are used extensively in ATCA specification in terms of the specifications for signals and connectors. While the AMC card, which is a mezzanine card, may be connected in a generally parallel planar arrangement with the ATCA motherboard as called for in the ATCA specification, presently, there are no options available for interfacing a non-ATCA motherboard that supports PCI-Express bus interfaces, for example, with an AMC card housed in packaging that complies with the MicroTCA specifications. Some prior art approaches in regard to interfacing with motherboards that support a PCI-Express bus interface include utilizing a cable arrangement to link a motherboard that supports a PCI-Express specified interface to a non-AMC compliant card that is configured for PCI-Express specification defined signaling. Several related prior art approaches are exemplified, for example, in U.S. Pat. Nos. 6,754,084, 7,170,753 and 7,172,432.

While these approaches may be useful in certain applications, electro-mechanical issues related to thermal, power management and/or protocol considerations may render these approaches inapplicable in certain other applications such as, for instance, applications that call for a non-ATCA compliant motherboard equipped with PCI-Express bus interfaces to communicate with and utilize AMC specification compliant modules configured for operation within a MicroTCA compliant system. Accordingly, it would be desirable to provide for a packaging and management arrangement that can interface an AMC card defined by a first electro-mechanical specification with a PCI-Express motherboard defined by a second electro-mechanical specification in such a way as to overcome the above-described challenges and still provide the advantages of compliance with both relevant specifications.

### SUMMARY OF THE INVENTION

The present invention provides for a modular chassis arrangement configured to provide mechanical, electrical, thermal, and feature conversion from a first packaging protocol to a second packaging protocol standard. In one embodiment the conversion is from a PCI-Express based serial I/O interconnect to a Advanced Mezzanine Card (AMC) form factor that is capable of supporting a multiplicity of AMC carrier boards, particularly Micro Telecom Computing Architecture (MicroTCA) carrier boards. In one embodiment, the present invention provides a drawer-like arrangement of MicroTCA carrier boards configured in a generally orthogonal orientation to a planar PCI-Express motherboard and interfaced with the PCI-Express connectors. In another embodiment, the modular chassis arrangement of the present invention is configured according to the Server System Infrastructure (SSI) standards.

In one embodiment, the present invention provides a cage that is received with a Personal Computer (PC) enclosure in the same manner a peripheral can be received within the PC. The cage is provided with fans, circuitry, connectors and structural features to create a ATCA or MicroTCA type environment required for the operation of an AMC card. The cage features a lateral connector for connecting to the motherboard and transferring PCI-Express protocolized signals between the cage and the CPU. The cage also features means to receive and support an AMC card within the ATCA and MicroTCA environment created for it by the cage. In this configuration, the CPU can communicate with the AMC card using the PCI-Express interconnect protocol as if the AMC card is another peripheral I/O device. In this manner, the present invention permits an advanced form factor AMC card to be tested and used within a PC environment suitable only for conventional form factor expansion cards and peripheral I/O devices.

### BRIEF DESCRIPTION OF THE PRESENT INVENTION

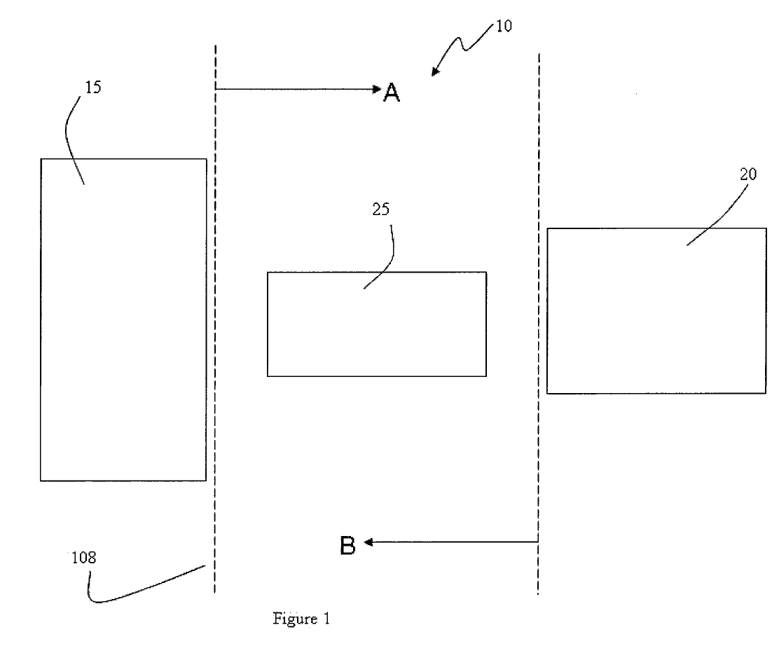

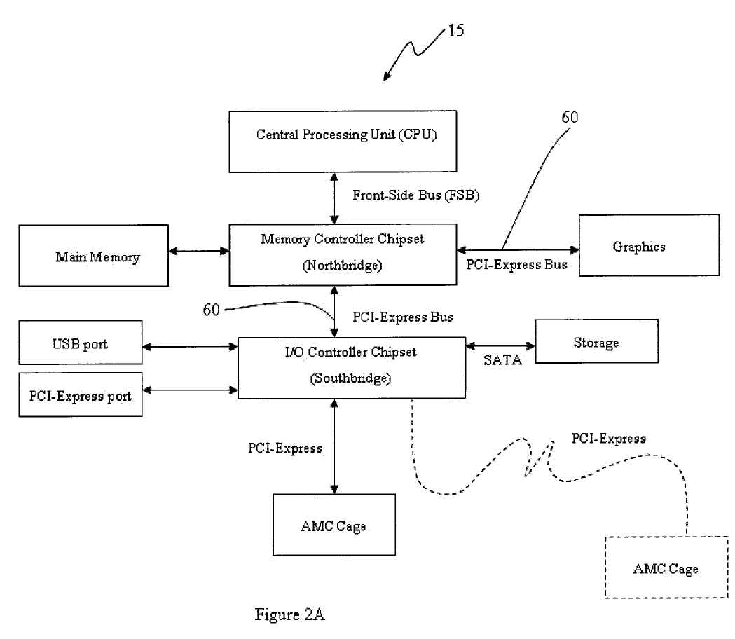

FIG. 1 is a functional block diagram representation of a computer system interfaced with an AMC module in accordance with an exemplary embodiment of the present invention.

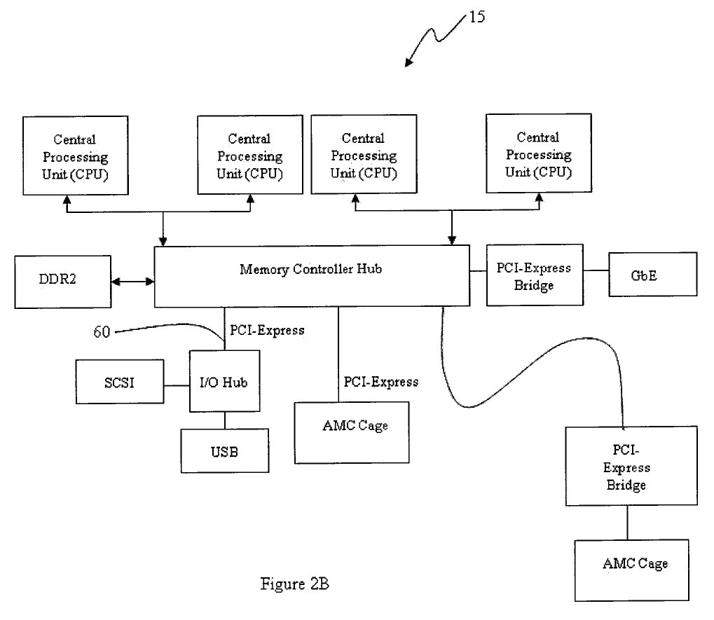

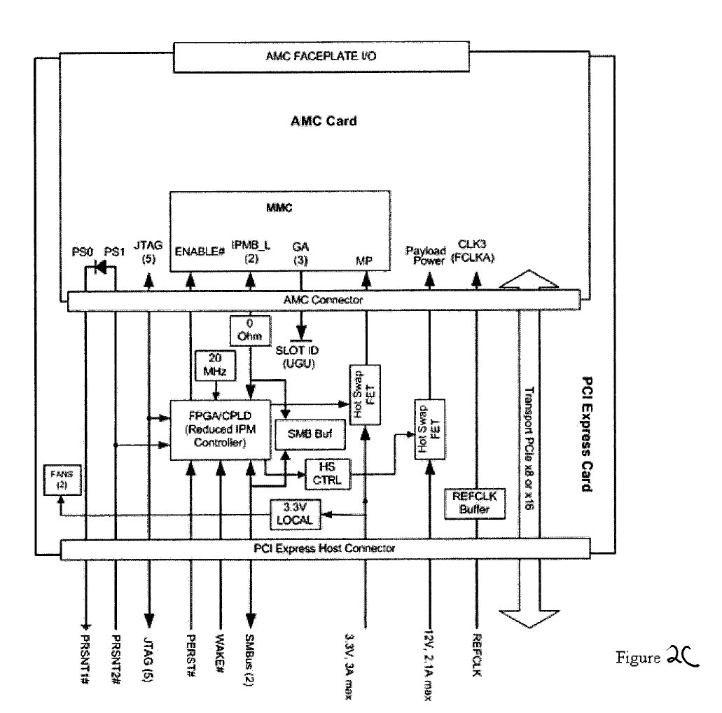

FIGS. 2A and 2B are logical representations of exemplary host computer systems within which embodiments of the present invention may be practiced.

FIG. 2C is a schematic representation of a conventional server architecture

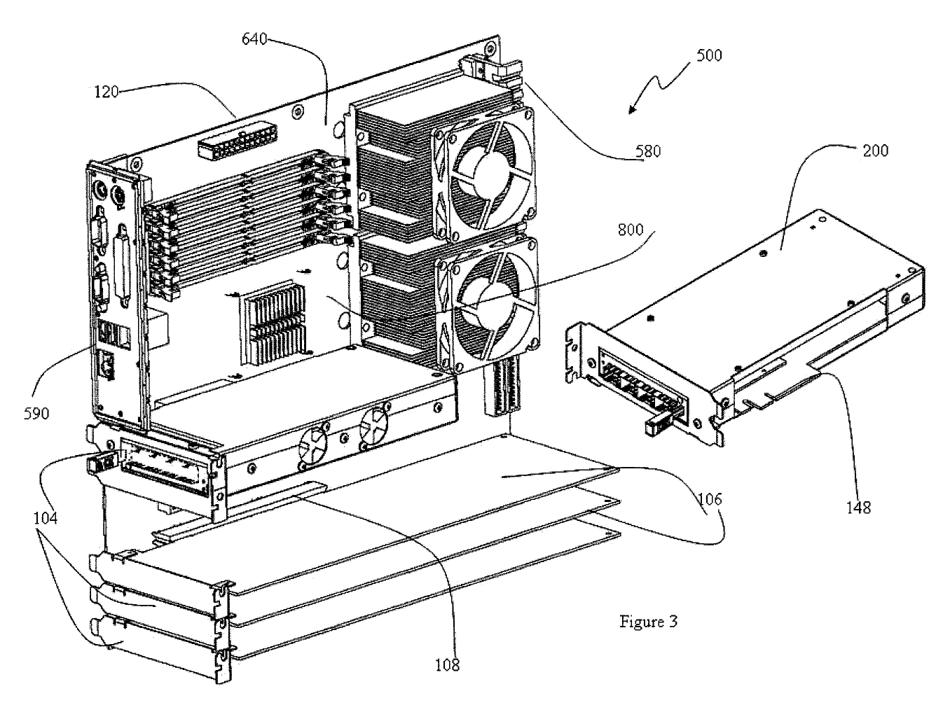

FIG. 3 is a perspective view of a tower PC accommodating a cage according to an exemplary embodiment of the present invention.

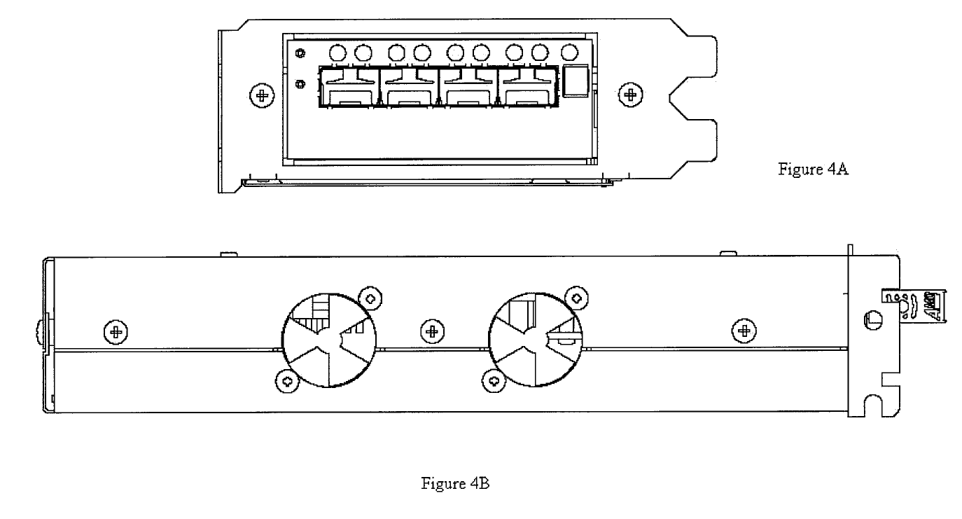

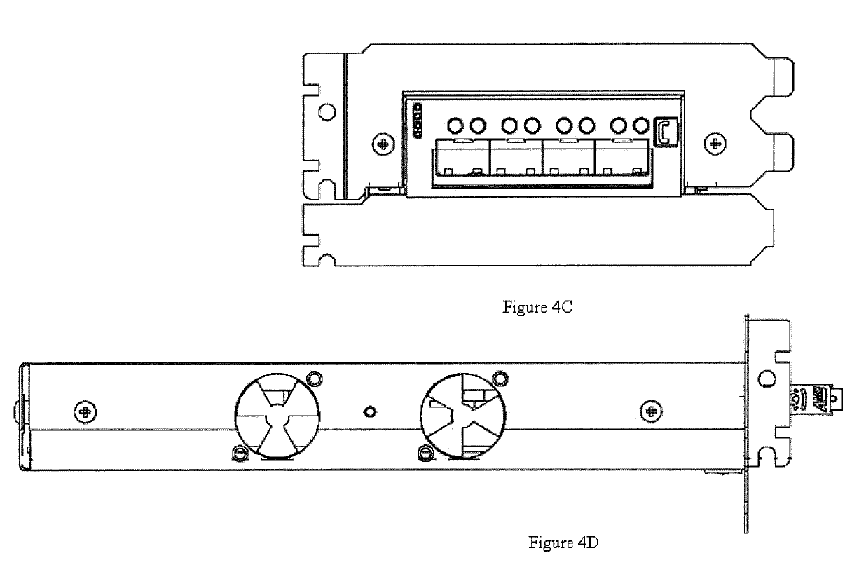

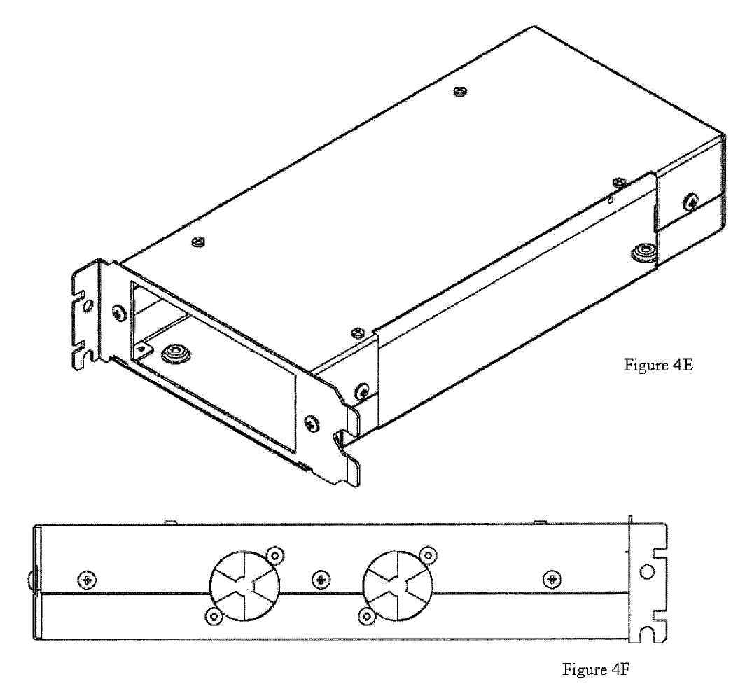

FIGS. 4A-4F are various views of a cage providing AMC-PCI-Express conversion and accommodating an AMC card according to the present invention.

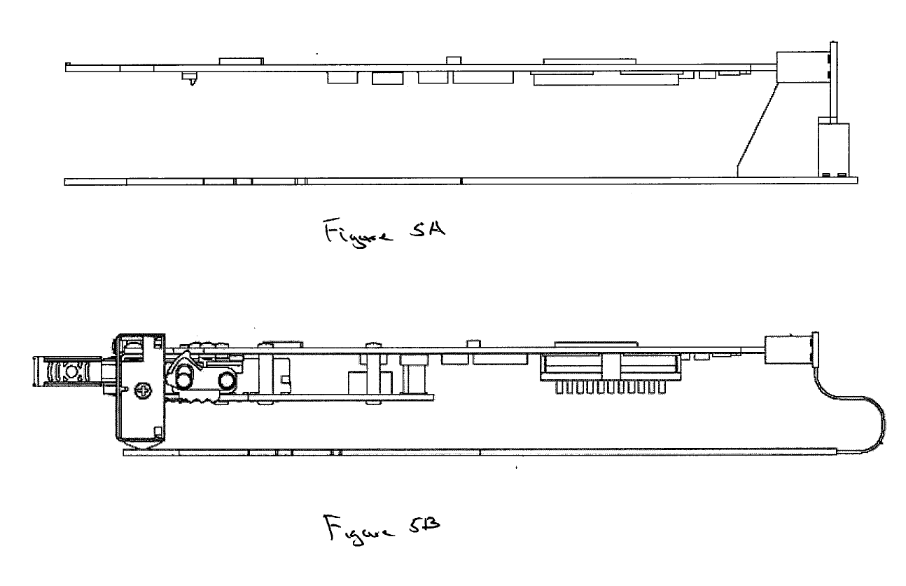

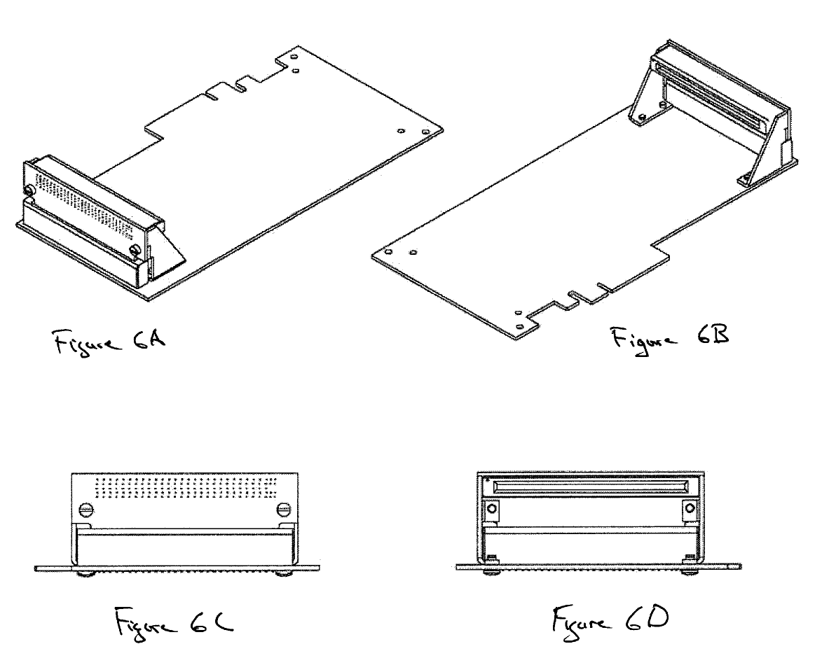

FIG. 5A-5B are side views of the cage assembly of the embodiments of the present invention.

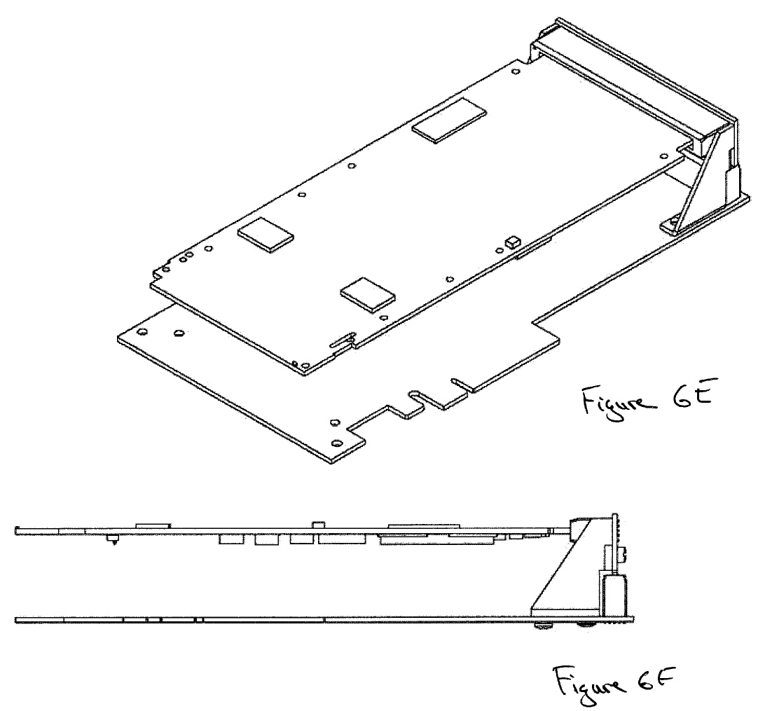

FIG. 6A-6E are various views of the AMC modules of embodiments of the present invention.

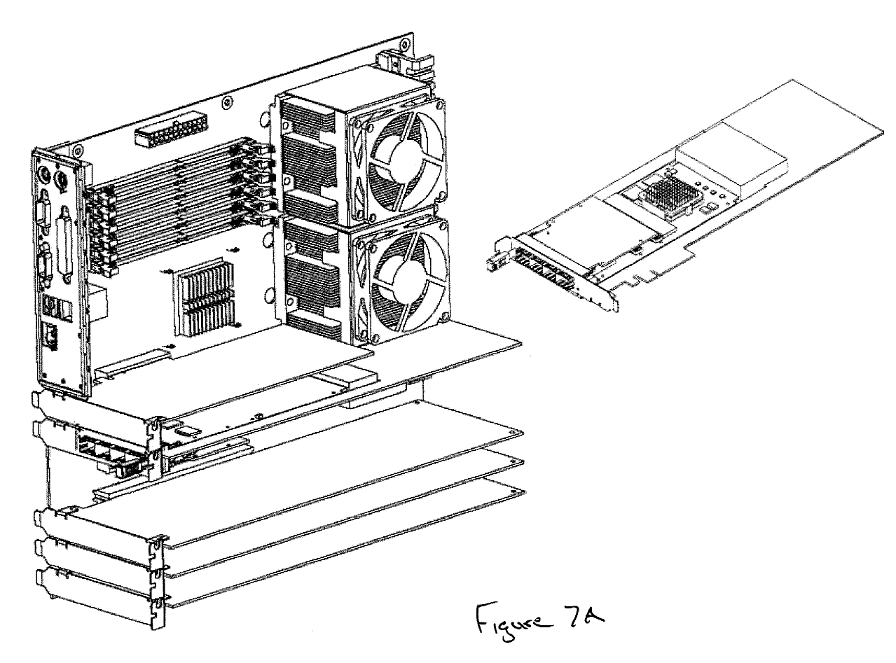

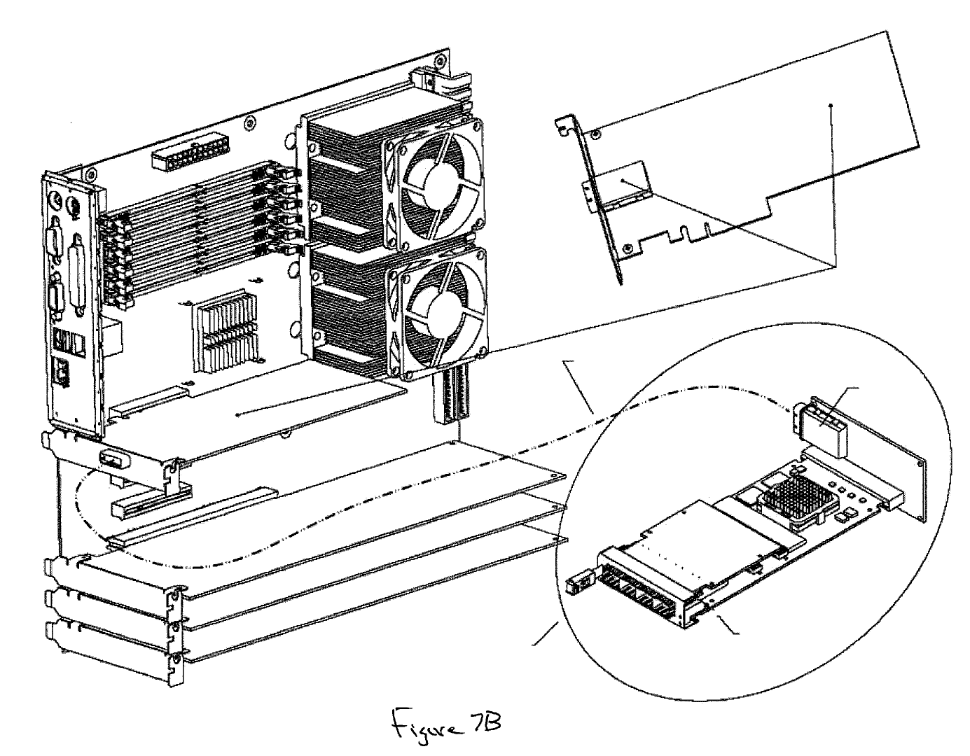

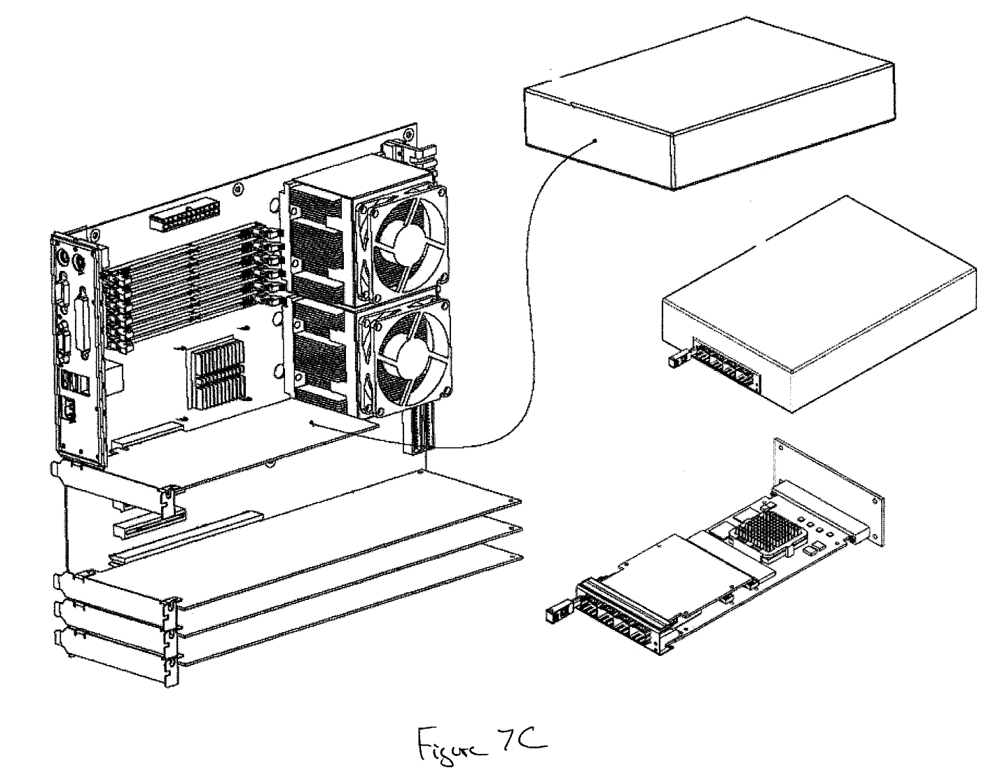

FIGS. 7A-7C are perspective views of a system incorporating embodiments of the present invention.

### DETAILED DESCRIPTION OF THE INVENTION

In the following description, reference is made to the accompanying drawings which form a part hereof and which illustrate several embodiments. In the following detailed description, numerous specific details are set forth to provide a full understanding of the present invention. It is understood that the present invention may be practiced without some of these specific details. In other instances, well-known structures and techniques have not been shown in detail so as to avoid unnecessarily obscuring the present invention.

FIG. 1 illustrates in functional block diagram form a system 10 wherein a host computer system 15 is electro-mechanically coupled to an Advanced Mezzanine Card (AMC) Specification compliant module 20 via a converter module (“Converter Module”) 25 according to one exemplary embodiment of the present invention. Converter Module 25 places the AMC module 20 and the host computer system 15 in communication for cooperative operation even where the specific standards-prescribed electro-mechanical environments and/or the native signaling protocols associated with each of these are incompatible.

Referring now to FIGS. 2A and 2B, there is shown in block diagram form, logical representations of exemplary architectures for host computer system 15 of FIG. 1. Host computer system 15 generally includes at least one central processing unit (CPU) 35 as depicted in FIG. 2A. CPU 35 may have a single processor core or multiple processor cores. CPU 35 may be communicatively coupled to one or more host computer system components through, for instance, a memory controller hub (MCH) 40 (alternatively “Northbridge”). In an exemplary embodiment, MCH 40 is communicatively coupled to one or more host computer system components such as, for example, a graphics card 45, system main memory 50, and an input-output (I/O) controller hub (“Southbridge”) 55 via a shared bus or point-to-point interconnect 60. In other embodiments of host computer system 15, the Southbridge may be integrated with the MCH 40 as shown, for instance, in FIG. 2B. In the exemplary embodiment illustrated in FIG. 1, 2A and 2B, interconnect 60 may be defined by a first technical standard. The first technical standard may define a peripheral component interconnect (PCI) type interconnect such as, for instance, the PCI-Express (PCI-e) interconnect defining a first platform and Input/Output (I/O) (i.e. first “Electro-Mechanical”) form factor and a first communication protocol as set forth by the PCI special interest group (PCI-SIG).

In this exemplary embodiment, MCH 40 includes a PCI-Express controller or “root complex” 65 as defined by the PCI-Express standard. Root complex 65 allows the CPU 35 to connect to and access the graphics card 45, the system main memory 50, the I/O controller hub 55 and any other device or devices that constitute the hierarchy of a PCI-Express topology. In alternate embodiments, the root complex 65 may be coupled to a bridge that allows the CPU to access a device connected to the bridge and configured to communicate using a non-PCI-Express signaling protocol such as for instance, GbE . . . . Host computer 15 maybe a computer, such as a desktop computer, server or similar machine wherein the CPU 35, the MCH 40, Southbridge 55 and other components may be co-located on a single printed circuit board 70 also known in the art as a “motherboard.” Motherboard 70 maybe a ATX, EATX(Extended ATX) or SSI (Server Side Includes) specified motherboard that is configured to support one or more PCI-Express bus interfaces or expansion slots for communicatively receiving an external function expansion card such as an audio card, a SCSI card and so forth.

In accordance with an exemplary embodiment of the present invention as illustrated in FIG. 2A, the platform and the I/O form factor conforms to or is backwards compatible with the ISA (Industry Standard Architecture) developed for IBM PC AT class of computing platforms. Exemplary standards may include, for example, EISA (Extended ISA), PCMCIA (PC Memory Card International Association) for notebooks, VLB (Vesa Local Bus, Video Local Bus) Video Electronics Standards Association, the PCI (Peripheral Component Interconnect) Local Bus/‘mezzanine’ style bus and the PCI-Express for serial I/O interconnects. IBM PC, and/or other IBM products referenced herein are either registered trademarks or trademarks of IBM Corporation. The PCI-Express serial interconnect attaches to the Central Processing Unit's (CPU)'s Local Bus through special ‘bridge’ or Hub chips that embody an architecture proprietary to the CPU manufacturer. The PCI-Express interconnect is backwards compatible with the PCI bus subsystem and, as seen in FIG. 2A, can be connected to the CPU's Local bus with a bridge chip, so the system remains compliant with ISA if desired.

In another embodiment, as illustrated in block diagram form in FIG. 2B, the host computer 12 is a server architecture configured according to the Server System Infrastructure (SSI) specification put forth by a consortium of industry vendors including Intel Corporation. Intel, Pentium, and/or other Intel products referenced herein are either registered trademarks or trademarks of Intel Corporation. It will be appreciated by one of skill in the art that the scope of the present invention is not necessarily restricted by any particular CPU-to-peripheral device interconnection architecture or by any interconnect protocol.

Referring again to FIG. 1, system 10 accommodates one or more modules 20 and interconnects with the modules 20 via Converter Module 25 using the first communication protocol. Modules 20 are configured to conform to an advanced form factor and for communicating using a second communication protocol defined by a second technical standard such as for example the AMC and the MicroTCA Specification.

FIG. 3 shows a perspective view of a computer chassis 500 constructed in accordance with the principles of the present invention and housing the circuitry and mechanicals constituting host computer system 15. As illustrated, computer chassis 500 is a computer tower that includes a rectangular cover 540, having a front side covered by a front panel 580, and a rear side covered by a second panel 590 to form an enclosure 640. In one embodiment, front and rear panels 580 and 590 may be hingedly attached to the computer chassis 500 to provide accessibility to enclosure 640. As further illustrated in FIG. 3, computer chassis 500 is constructed with a frame 700 which, along with cover 540, front panel 580 and rear panel 590 define a plurality of compartments or bays 800 within enclosure 640. Cover 540, front and rear panels 580 and 590 may comprise a stamped, drawn, or riveted metal manufacture to securely support the computer system and serve as a base electromagnetic interference (EMI) shield for components and devices that may be installed within enclosure 640.

In an exemplary embodiment, one or more compartments or bays 800 are configured to receive and support a motherboard 120, daughter boards, power module, fan modules and peripheral devices. As used herein, the term “peripheral device” is used in a broad sense, encompassing any physical entity for performing a function so as to provide a capability to the host system. Accordingly, “peripheral devices” may include, by way of example and not limitation, computer hard drives, floppy drives, CD-ROM drives, printers, scanners, speakers, digital cameras, business card readers, keyboards, mice, joysticks, as well as telephone lines, Ethernet local area networks, integrated services digital network (ISDN) and digital subscriber line (DSL). One embodiment of the invention features the fan trays as peripheral devices. Additionally, rear panel 590 includes apertures 104 (i.e. expansion slots) 104 for slidably receiving cards or modules (alternatively boards, expansion boards/cards) 106 equipped with circuitry and devices not provided on the motherboard 120. The apertures 104 are arranged so that the major surface of each card is received perpendicular to each of the front and rear panels 580 and 590 the card 104 is slidably guided from the rear to the front direction until it enters into mating relationship with a connector or other mechanical arrangement 108 on the motherboard 120 which serves to mechanically and electrically couple the card or module 104 to the PCI bus, PCI-Express interconnect other communication bus through which the card or module 106 can communicate with the CPU or other parts of the system 10 depicted in the illustrations of FIGS. 1, 2A and 2B. PCI-Express slots or connectors 108 on the motherboard mate with edge connectors 148 on the card edge to communicatively couple the card to the PCI-Express bus and thereby to the CPU. This arrangement serves to expand the ability of the motherboard to interoperate with and control peripheral devices other than those natively provided in system 10. The dimensions of the apertures 104, the spacing between the apertures and the volume 114 occupied by the cards/modules received through the apertures into enclosure 64 conforms to a relevant technical standard, such as, for example, the ISA standard described above to enable modular construction and interoperability between modules provided by the vendors' industry. Each of the front and rear panels 580 and 590 also feature a series of slits (not shown) through which the fan or fans in the fan tray mounted within enclosure 640 aspirate and discharge air for cooling the enclosure 640. Other structural configurations may be utilized within the scope of the present invention. Although FIG. 3 depicts a computer tower other structural configurations of the computer chassis 500 such as for example, pizza-box type PC, mobile notebook computer, rack mounted server or other similar structural configurations well known in the art may be used within the scope of the present invention. It will be appreciated that the physical and electrical characteristics of system 500, including the electro-mechanical characteristics of connectors 108, define a first platform and Input/Output (I/O) (i.e. first “Electro-Mechanical”) form factor and the PCI-Express (PCI-e) interface provided by the connector 108 to the motherboard 120 defines a first communication protocol as such terms are used in a previous paragraph in connection with the description of host system 15 of FIGS. 1, 2A and 2B.

Referring now to FIGS. 3-7 there is illustrated the PCI-Express to AMC conversion cage 200 according to one embodiment of the present invention includes at least one front face plate, a top cover separated by a plurality of spacers from a bottom cover so as to enclose a AMC environment compartment between the top and bottom cover and create an aperture on the front face plate that communicates with the AMC environment compartment. The faceplate lies parallel to a short axis of the cage. An expansion card is provided within the AMC environment compartment proximate the bottom cover. The expansion card is configured with an AMC connector (such as the one supplied by Yamaichi Semiconductor) fixedly attached to an edge proximate the rear of the cage opposite the front face plate for inserting and supporting a AMC card. A plurality of spaced apart guide ways are defined within the AMC environment compartment above the expansion card and configured to receive thereon an AMC card and for slidingly guiding the card toward the rear of the cage towards the AMC connector.

According to one aspect as depicted in FIG. 3, the cage is dimensioned to be received through a standard aperture (defined according to the PC Open Standard such as the ISA for example) on the rear panel 60 of the PC tower. The expansion card is equipped with the circuitry and devices that emulate the ATCA carrier environment specified in AMC.0. The expansion card provides interconnect, power conversion, clock distribution, fabric features and system management functionality of the ATCA specification. In addition, the expansion card provides at least one card edge connector located along a long edge of the expansion card extending transverse to a long axis of the cage and extending outside the AMC environment compartment. One or more than one row of contact terminals are embedded into a single lateral side of the card edge connector suitable for being received within a female PCI-Express connector such as the connectors on the motherboard in FIG. 3. Circuitry on the expansion card converts signals from the AMC connector to PCI-Express and makes them available to the contacts on the card edge connector. PCI-Express received at the card edge connector are converted to AMC signals and supplied to the AMC connector.

In one embodiment, the cage is inserted into the PC Tower enclosure through the rear panel and the card edge connector is mated to an available PCI-Express connector on the motherboard as depicted in FIG. 3. At least one fan is fixedly attached to the cage proximate the long edge of the expansion card opposite the card edge connector. The fans serve to move air through the AMC environment compartment transverse to the direction of flow of air through the PC tower enclosure. In effect, the cage acts as a virtual carrier for the AMC card inserted into the AMC environment compartment as will now be described.

Referring now to FIGS. 5 and 6, there is illustrated an AMC card inserted within the cage through the aperture in the faceplate. The AMC card is well known in the art and includes a AMC card edge connector at one end and a face plate with latch on the other end. The AMC card is inserted through the aperture into the AMC environment compartment wherein it is supported on the guide ways as it is being progressively inserted into the cage until the AMC card edge connector mates with the AMC connector at the back of the cage as described in the previous paragraph. In this configuration, the CPU can communicate with the AMC card as if it is another I/O card. The expansion card provides the AMC to PCI-Express conversion that is totally transparent both to the AMC card, the CPU and the rest of system 10.

In another embodiment of the present invention, the expansion card provides support to enable hot pluggable operation of the AMC card. Another feature of the present invention is that a single cage can support a plurality of expansion cards or several cages can be arranged in a stacked configuration so that their card edge connectors are above one another and coupled to a single backplane (not illustrated) which in turn couples to the PCI-Express connectors on the motherboard through, for example, a flexible cable.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A system to provide AMC to PCI-Express protocol conversion as shown and described.

2. A method to provide AMC to PCI-Express protocol conversion as shown and described.
